(19) United States
(12) Patent Application Publication
(10) Pub. No.: US 2007/0162399 A1
(43) Pub. Date: Jul. 12, 2007

(54) Method and apparatus for providing broadcast trigger messages

(76) Inventors: Alexander Medvinsky, San Diego, CA (US); Joon Young Park, Issaquah, WA (US); Petr Peterka, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/316,236

(22) Filed: Dec. 22, 2005

(51) Int. Cl. G06Q 99/00

(52) U.S. Cl. 705/59

(57) ABSTRACT

The present invention discloses an apparatus and method for obtaining rights management data for broadcast or multicast content. In one embodiment, a broadcast trigger message is obtained from a broadcast source. At least one content license identifier from said broadcast trigger message is obtained. Afterwards, at least one content license file associated with said at least one content license identifier is requested. Notably, the broadcast trigger message is shared by all endpoint devices while the content license file is uniquely adapted for the requesting endpoint device.

### BACKGROUND OF THE INVENTION

1. Field of the Invention

Embodiments of the present invention generally relate to broadcast content delivery networks, e.g., video-over-IP networks. More specifically, the present invention relates to a method and apparatus for associating content rights with broadcast content in a multicast video-over-IP network.

2. Description of the Related Art

Digital content has gained wide acceptance in the public. Such content includes, but is not limited to: movies, videos, music and the like. Consequently, many consumers and businesses employ various digital media devices or systems that enable the reception of such digital multimedia contents via mobile devices. Presently, Digital Rights Management (DRM) protocols (e.g., Open Mobile Alliance DRM protocol) are designed for point-to-point clients and utilize Rights Object Application Protocol (ROAP) trigger messages to facilitate the secure delivery of content. Specifically, trigger messages are used to provide clients with identifiers of content license files, which enable an endpoint device to obtain the requisite content license files (e.g., Rights Objects) to view encrypted content. The trigger messages are typically provided to point-to-point clients that visit a dedicated web site and select certain content. However, this process is not feasible in the case of broadcast services. Because broadcast service keys change periodically, a broadcast service client would be required to receive updated information (e.g., service keys) on a periodic basis as well. In addition, scalability concerns would arise if a Rights Issuer (e.g., a server that generates content license files) was required to transmit the same trigger message corresponding to an updated service key to each individual client.

Thus, there is a need in the art for a method and apparatus for providing broadcast trigger messages to a plurality of endpoint devices.

### SUMMARY OF THE INVENTION

In one embodiment, an apparatus and method for obtaining rights management data for broadcast or multicast content is described. Specifically, a broadcast trigger message is obtained from a broadcast source. At least one content license identifier from said broadcast trigger message is obtained. Afterwards, at least one content license file associated with said at least one content license identifier is requested. Notably, the broadcast trigger message is shared by all endpoint devices while the content license file is uniquely adapted for the requesting endpoint device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for providing broadcast trigger messages in accordance with the present invention;

FIG. 2 depicts a method for providing broadcast trigger messages in accordance with the present invention; and

FIG. 3 is a block diagram depicting an exemplary embodiment of a computer suitable for implementing the processes and methods described herein.

To facilitate understanding, identical reference numerals have been used, wherever possible, to designate identical elements that are common to the figures.

### DETAILED DESCRIPTION

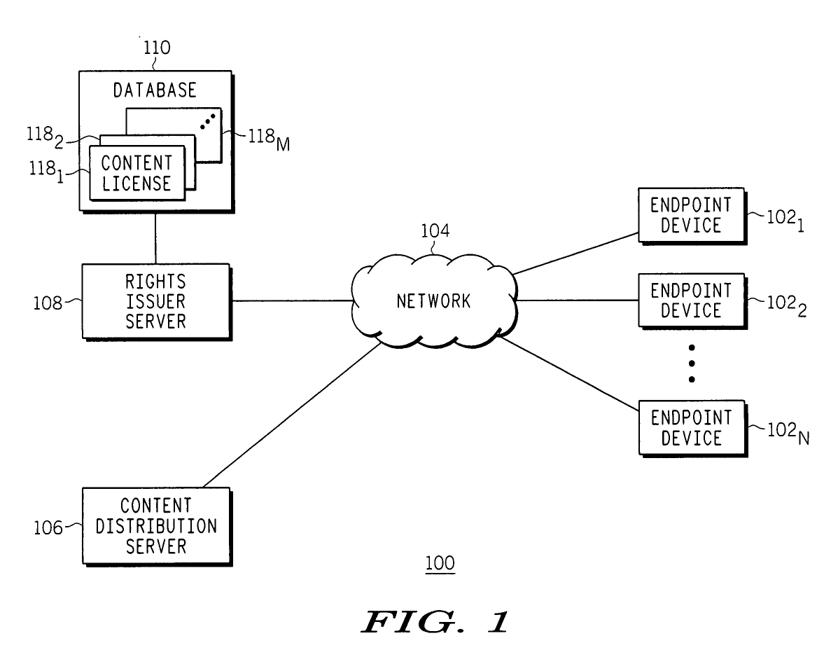

FIG. 1 illustrates a content distribution system 100 of the present invention. The content distribution system 100 may be a broadcast (i.e., multicast) video-over-IP network utilizing a Digital Rights Management (DRM) system, such as an Open Mobile Alliance (OMA) DRMv2 system and the like. In one embodiment, the content distribution system 100 comprises a plurality of endpoint devices 102_{1 . . . n} that are linked to a conventional data communications network 104 (e.g., the Internet, LAN, WAN, and the like). The communications network 104 may also include a wireless delivery network, such as a cellular network. Therefore, the connections linking the endpoint devices 102_{1 . . . n} to the network 104 may be wireless links. Notably, the endpoint devices 102_{1 . . . n} may include cellular phones, personal digital assistants (PDAs), portable audio/video players, video devices mounted in automobiles, or any other type of like mobile devices. The communications network 104 is also connected to a content distribution server 106 and a Rights Issuer (RI) server 108. For the sake of simplicity, only one content distribution server 106 and only one RI server 108 are shown. Those skilled in the art understand that a plurality of content distribution servers or RI servers may be connected to the communications network 104 to form a larger system. The RI server 108 may also be coupled to at least one database 110.

The content distribution server 106 may comprise a stand alone server (or plurality of servers) that is responsible for providing subscribed content to the endpoint devices 102_{1 . . . n}. Depending on the embodiment, the content may include a Pay-Per-View (PPV) program, a subscribed service, or the like. The content distribution server 106 is utilized by the service provider to receive content from a content provider. The content distribution server 106 then distributes the requested PPV program (or service) in an encrypted format over a broadcast or IP Multicast network to the endpoint devices. Only the subscribing endpoint devices or devices where the subscriber is authorized for a current PPV program will have the necessary cryptographic keys to decrypt this content.

The Rights Issuer (RI) server 108 comprises a dedicated server (or plurality of servers) that is responsible for providing content license files 118_{1 . . . m} to requesting endpoint devices 102. A content license file 118 comprises a secure file (e.g., authenticated and/or encrypted file) that contains both encrypted key material (e.g., service keys used to encrypt/decrypt the traffic keys that encrypt the actual program content) as well as permissions (e.g., user rights associated with the content) that enable a endpoint device to decrypt and properly display PPV content (or likewise, utilize subscribed services). In one embodiment, the content licenses comprise Open Mobile Alliance (OMA) Rights Objects (ROs). The content license files 118 are contained in a database 110 coupled to an RI server 108. Specifically, the content of the license files may be stored in the database 110, but the generation of the ROs (i.e., wrapping) is performed using the public key (or some other shared secret) that is unique to the endpoint device.

The RI server 108 may also be configured to provide a trigger message stream at a particular multicast Internet Protocol address. The trigger message stream is a continuous flow of data that comprises a plurality of triggers, wherein each trigger corresponds to a particular service or PPV program that is offered by a service provider (via the content distribution server 106). Notably, when associated with a subscription service, each trigger contains a pair of identifiers (a “current” identifier and a “next” identifier) that corresponds to a “current” content license file and a “next” content license file. In one embodiment, all of the content license files 118_{1 . . . m} are contained in the database 110. Notably, the content of the license files may be stored in the database 110, but the creation of the ROs is performed using the public key that is unique to the endpoint device. In one embodiment, the trigger message stream comprises a Rights Object Acquisition Protocol (ROAP) trigger message that is embodied in a binary format.

An endpoint device subscribing to at least one service (and thus requires at least one content license file) may access the designated multicast IP address (which may be obtained from a registration process with the RI server) to receive the trigger message stream. After accessing the designated multicast IP address specified by the RI server 108, the endpoint device 102 filters the streaming trigger messages to only obtain the triggers containing the requisite content license identifiers (e.g., only the identifiers required for the endpoint device's subscribed services). Once the proper identifiers are acquired, the endpoint device 102 subsequently contacts the RI server 108 and requests the necessary content license 118 associated with the “current” content license identifier obtained from the trigger message for a subscription service. The RI server 108 then accesses the database 110 and acquires the appropriate content license, which is subsequently provided to the requesting endpoint device 102. Although the content of the license files may be stored in the database 110, it is important to note that the creation of the ROs is performed using the public key that is unique to the endpoint device. Notably, the entire process is conducted in a manner that is completely transparent to the user of the endpoint device 102.

In addition to obtaining the requisite “current” content license, the endpoint device 102 is also configured to request a “next” content license file for a subscription service, which is needed to decrypt/view the customer's subscribed content upon the expiration of the “current” content license file. In one embodiment, the endpoint device 102 obtains the “next” content license file in a manner similar to the process described above. One exception is that the “next” content license is obtained after a random delay (following the acquisition of the “current” content license file) in order to avoid lags caused by performance bottle necks at the RI server 108.

After obtaining both the “current” and next” content license files, the endpoint device 102 no longer needs to request a “current” content license file again since the “next” content license file ultimately becomes a new “current” content license upon the expiration of the presently utilized content license file. However, the endpoint device 102 will continue to automatically request (with random delays) subsequent “next” content license files prior to the expiration of the most recently obtained content license file. For example, when a “current” content license expires, the “next” content license becomes the new “current” content license. The endpoint device 102 is now able to seamlessly view the streaming subscribed content (during the transition between the expired content license and the new “current” content license), but does not have a “next” service key in waiting. Consequently, the endpoint device 102 contacts the multicast IP address and accesses the trigger message stream. Notably, the endpoint device is able to acquire the necessary trigger to access the “current” content license identifier and the “next” content license identifier. However, since the endpoint device already possesses the “current” content license file (i.e., the former “next” content license that became the most recent “current” content license file that is presently being used to view the subscribed content), only the “next” content license file identifier is needed, and therefore obtained. The endpoint device subsequently contacts the RI server 108 (after a random delay) to acquire a new “next” content license file using the recently acquired “next” content license identifier. Once the “current” content license file expires, this “next” content license identifier becomes the new “current” content license file in the manner described above.

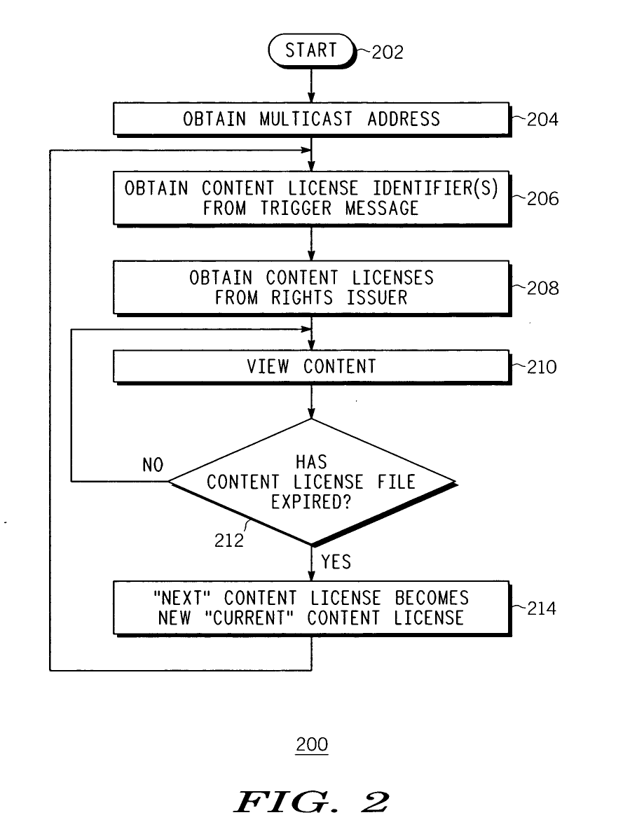

FIG. 2 illustrates a method 200 for utilizing broadcast triggers in accordance with the present invention. Method 200 begins at step 202 and proceeds to step 204, where an endpoint device (e.g., a mobile device) acquires a multicast IP address for receiving triggers. In one embodiment of the present invention, the endpoint device 102 obtains a multicast IP address from a Rights Issuer (RI) server 108 during an initial registration phase.

At step 206, content license identifiers are obtained. In one embodiment, the endpoint device 102 accesses an appropriate multicast IP address (received from step 204) and receives a trigger message stream. The trigger message stream comprises a plurality of triggers associated with the services provided by the network provider (via the content distribution server 106). The endpoint device 102 filters the trigger message to only receive the necessary triggers associated with the specific services that the endpoint device 102 has subscribed to receive. From these triggers, the endpoint device is able to extract the necessary content license identifiers (e.g., a “current” content license identifier and a “next” content license identifier).

At step 208, the content license files are obtained. In one embodiment, the endpoint device 102 communicates with the RI server 108 and acquires the “current: content license files (e.g., Rights Objects) that correspond to the “identifiers” obtained from the broadcast trigger message stream. Depending on the embodiment, the endpoint device may obtain both the “current” content license file and the “next” content license file simultaneously, or the endpoint device may be configured to request the “next” content license file after obtaining the “current” content license file (after a random delay).

At step 210, subscribed content is viewed. In one embodiment, the endpoint device 102 utilizes a service key within a content license file to decrypt and view the subscribed content provided by the service provider.

At step 212, a determination whether the “current” content license has expired is made. If the current content license has not expired, then the method 200 loops back to step 210. If the current content license has expired, then the method 200 continues to step 214 where the “next” content license becomes the new “current” content license. The method 200 then loops back to step 206. In one embodiment, the endpoint device only obtains the new “next” content license identifier from the trigger message stream since the “current” content license identifier was the former “next” content license file identifier that was previously obtained.

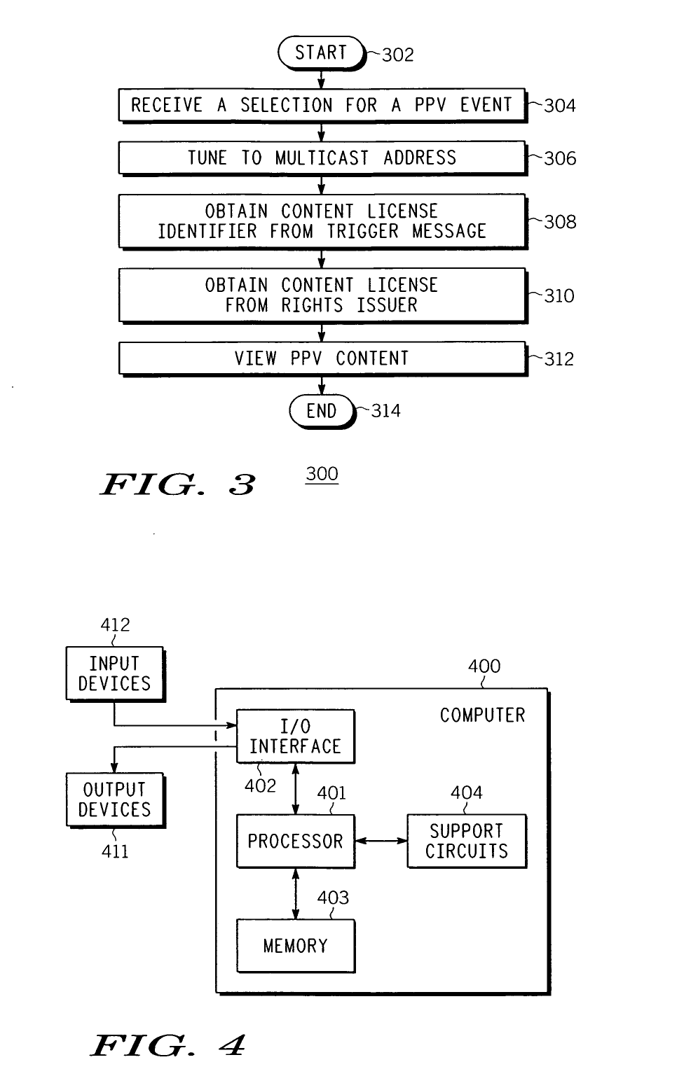

In addition to obtaining a content license for a subscribed service, the endpoint device 102 may also request a content license file for a PPV event. A user may browse available PPV events through a local user interface on a device (e.g., a schedule of available PPV events has already been delivered to the device, such as an Electronic Service Guide (ESG) file delivered over a reliable multicast). FIG. 3 illustrates a method 300 for utilizing broadcast triggers in accordance with a PPV event. Method 300 begins at step 302 and proceeds to step 304 where a selection for a PPV event is received. In one embodiment, a user selection for a desired PPV event is locally received by the device. At step 306, the requisite multicast address is tuned to. In one embodiment, the user selection will cause the device to automatically tune to the appropriate multicast IP address.

At step 308, content license identifier(s) are obtained from a trigger message. In one embodiment, the correct broadcast trigger for the desired PPV event is located and the corresponding content license identifiers are acquired. Notably, the endpoint device is able to extract the necessary content license identifier. Typically, a PPV event only requires a single content license, therefore only the acquisition of a single content license identifier is necessary (as opposed to obtaining a “next” content license identifier). At step 310, a content license is obtained from a Rights Issuer. In one embodiment, the device will then acquire the content license from a Rights Issuer server and will then have the necessary Program Key to decrypt the PPV program. In one embodiment, the Rights Issuer records the request and forwards it to a billing system, whereby the subscriber is billed or charged for the PPV purchase.

At step 312, the PPV content is viewed. The method 300 proceeds to step 314 and ends.

FIG. 4 is a block diagram depicting an exemplary embodiment of a computer 400 suitable for implementing the processes and methods described herein. Notably, the computer 400 may be used to implement the endpoint device 102 (e.g., a mobile device, a cellular phone, a PDA, and the like) of FIG. 1 and the methods 200 and 300 of FIGS. 2 and 3. The computer 400 includes a central processing unit (CPU) 401, a memory 403, various support circuits 404, and an I/O interface 402. The CPU 401 may be any type of microprocessor known in the art. The support circuits 404 for the CPU 401 include conventional cache, power supplies, clock circuits, data registers, I/O interfaces, and the like. The I/O interface 402 may be directly coupled to the memory 403 or coupled through the CPU 401. The I/O interface 402 may be coupled to various input devices 412 and output devices 411, such as a conventional keypad, touch screen, displays, and the like.

The memory 403 may store all or portions of one or more programs and/or data to implement the processes and methods described herein. Notably, the memory 403 may store to be executed by the CPU 401 for performing the methods 200 and 300 of FIGS. 2 and 3. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs. The memory 403 may include one or more of the following random access memory, read only memory, magneto-resistive read/write memory, optical read/write memory, cache memory, magnetic read/write memory, and the like, as well as signal-bearing media as described below.

An aspect of the invention is implemented as a program product for use with a mobile device or computer. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media; or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to embodiments of the present invention, other and further embodiments of the invention may be devised without departing from the basic scope thereof, and the scope thereof is determined by the claims that follow.

1. A method for obtaining rights management data for content, comprising:
obtaining a broadcast trigger message from a broadcast source;
obtaining at least one content license identifier from said broadcast trigger message; and
requesting at least one content license file associated with said at least one content license identifier.

2. The method of claim 1, wherein said at least one endpoint device comprises at least one of: a cellular phone, a portable video player, an automobile video player, or a personal digital assistant (PDA).

3. The method of claim 1, further comprising:
obtaining an address of said broadcast source; and
accessing said broadcast trigger message at said address.

4. The method of claim 1, wherein said step of obtaining said at least one content license identifier comprises:
filtering said broadcast trigger message to obtain said at least one content license identifier.

5. The method of claim 1, wherein said broadcast source comprises a multicast Internet Protocol (IP) address.

6. The method of claim 1, further comprising:
obtaining at least one update associated with said at least one content license file prior to an expiration of said at least one content license file.

7. The method of claim 6, wherein said at least one update replaces said at least one content license file upon the expiration of said at least one content license file.

8. The method of claim 1, further comprising:
accessing automatically an address of said broadcast source in response to a received request for a pay-per-view (PPV) event; and
accessing said broadcast trigger message at said address.

9. A system for utilizing a broadcast trigger message, comprising:
a rights issuer server for generating said broadcast trigger message at a broadcast source and storing a plurality of content license files; and
a plurality of endpoint devices, wherein at least one of said plurality of said endpoint devices obtains said broadcast trigger message from said broadcast source, obtains at least one content license identifier from said broadcast trigger message, and acquires at least one content license file associated with said at least one content license identifier from said rights issuer server.

10. The system of claim 9, wherein said at least one of said plurality of said endpoint devices comprises at least one of: a cellular phone, a portable video player, an automobile video player, or a personal digital assistant (PDA).

11. The system of claim 9, wherein said at least one of said plurality of said endpoint devices obtains an address of said broadcast source and accesses said broadcast trigger message at said address.

12. The system of claim 9, wherein said broadcast source comprises a multicast Internet Protocol (IP) address.

13. The system of claim 9, wherein said at least one of said plurality of said endpoint devices is further configured to obtain at least one update associated with said at least one content license file prior to an expiration of said at least one content license file.

14. The system of claim 13, wherein said at least one update replaces said at least one content license file upon the expiration of said at least one content license file.

15. The system of claim 9, wherein said at least one of said plurality of said endpoint devices is further configured to automatically access an address of said broadcast source in response to a received request for a pay-per-view (PPV) event and to access said broadcast trigger message at said address.

16. An apparatus for obtaining rights management data for content, comprising:
means for obtaining a broadcast trigger message from a broadcast source;
means for obtaining at least one content license identifier from said broadcast trigger message; and
means for requesting at least one content license file associated with said at least one content license identifier.

17. The apparatus of claim 16, further comprising:
means for obtaining an address of said broadcast source; and
means for accessing said broadcast trigger message at said address.

18. The apparatus of claim 16, wherein said means for obtaining said at least one content license identifier comprises:
means for filtering said broadcast trigger message to obtain said at least one content license identifier.

19. The apparatus of claim 16, further comprising:
means for obtaining at least one update associated with said at least one content license file prior to an expiration of said at least one content license file.

20. The apparatus of claim 16, further comprising:
means for accessing automatically an address of said broadcast source in response to a received request for a pay-per-view (PPV) event; and
means for accessing said broadcast trigger message at said address.
